(19) United States
(12) Patent Application Publication
(10) Pub. No.: US 2010/0192074 A1
(43) Pub. Date: Jul. 29, 2010

(54) PLUGGABLE MARGIN EXTENSION

(75) Inventors: Fiona Fung, Bellevue, WA (US); John Tilford, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/360,999

(22) Filed: Jan. 28, 2009

(51) Int. Cl. G06F 3/048

(52) U.S. Cl. 715/763

(57) ABSTRACT

Pluggable margin extensions provide user interface controls around an editor's displayed content based on the type of content being viewed. Which margin extensions are displayed may change if the type of content being viewed changes. A margin extension has a spatial orientation relative to the editor's content display. A margin extension may include an order relative to another margin extension for placement on the display, and a margin extension's visible interface may overlay the interface of another margin extension.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### BACKGROUND

Software user interfaces are organized in a wide variety of different ways. For example, some user interfaces are built by developers using a widget toolkit. The look and feel of user interface widgets may be fixed (hard-coded), or may be decoupled to allow changes during runtime.

Some programs use a user interface component known as a “toolbar”. Some application program toolbars are defined by the application developer as a row of buttons or icons representing a fixed set of commands. Some programs allow a user to customize the appearance and/or screen placement of a toolbar that is being displayed by the program.

Some programs use a “ribbon”, namely, a graphical user interface widget that is displayed as a strip along the top of a user interface window to expose in one place the functions the program offers. A program may also display additional ribbons, as additional functions become available when the user changes context within the program. Ribbons consolidate program functions and commands in a readily recognized location, so that users do not need to navigate through multi-level hierarchical menus, toolbars, or task panes to find a desired command.

### SUMMARY

Pluggable margin extensions provide user interface controls around an application's displayed content based on the type of content being viewed, without being hard-coded as part of the application. In some embodiments, pluggable margin extensions are arranged in a hierarchy according to a relative order specified in each margin extension. For example, a given margin extension may include an order indicating it can be placed on screen in a margin area location that is less central than another margin extension's location, that is, in a location that is nearer an outer edge of the application's user interface display area. Each margin extension also has a spatial orientation, chosen from a multi-directional group of orientations such as “above, below, left-of, or right-of” a content display area, such as the area displaying text in an editor. In some embodiments, the user interface of one margin extension may overlay the user interface of another margin extension. Some embodiments change the margin extensions being displayed if the type of content being viewed changes, e.g., a margin extension compatible with a table of numbers might not be compatible with C# source code, and vice versa.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having a processor, a memory, an application program with a user interface which may be supplemented by margin extension user interfaces, and other items in an operating environment, and also illustrating configured storage medium embodiments;

FIG. 2 is a block diagram further illustrating margin extensions;

FIG. 3 is a diagram further illustrating display areas and user interface placements;

FIG. 4 is a block diagram further illustrating margin extension implementation; and

FIG. 5 is a flow chart illustrating steps of some method and configured storage medium embodiments.

### DETAILED DESCRIPTION

Overview

In some Microsoft Visual Studio® environments, margins are static entities around a VSTextView object in an editor. No convenient mechanism is provided to allow Visual Studio® Industry Partners program members or external customers to extend margin functionality by adding their own margin tool implementations. A basic set of margin functions is included, e.g., line number margin, vertical scrollbar, horizontal scrollbar, and dropdown margin. However, alternate or supplemental implementations of those margins, which in hindsight may have been helpful, were not facilitated because no mechanism was provided to place them in the environment to work with the editor.

Some embodiments discussed herein provide an extensible margin system in a view such as a Microsoft Visual Studio® environment text editor view. Through a margin extensibility API, developers specify what types of textview or other view they want a margin extension appended to. A margin extension developer also specifies a spatial orientation of a margin extension's visible user interface with respect to the view (top, bottom, left, or right), and a relative ordering with other margin extensions and/or the application's permanent/hard-coded margins. Developers also supply a margin extension implementation. Upon creation of a view, the view (depending on its content type and category) will automatically call on compatible margin extensions to supply their margin functionality, and will place the margin extensions in suitable locations on screen. If multiple margin extensions of the same type (e.g., line number margins) are supplied, a view may choose the margin extension whose characteristics best suit the view's criteria (most recent, has particular functionality, fastest, etc.).

In some embodiments, margin extensions include a horizontal/vertical order with respect to other margin extensions. In some, margin extensions may also specify that they are overlay compatible. For example, other margin extensions can specify that they should be overlaid on top of this margin extension when displayed. Margin extensions may specify their z-ordering (display depth) with respect to other overlay-compatible margin extensions.

In some embodiments, views are able to support an arbitrarily large number of margin extensions. In other embodiments, the number of margin extensions is capped, due to the limited size of the screen's margin area and/or other resource constraints.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, and/or device(s) providing one or more processors controlled at least in part by instructions. The instructions may be in the form of software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to synchronization, and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit. For example a hyperthreaded quad core chip running two threads per core has eight logical processors. Processors may be general purpose, or they may be tailored for specific uses such as graphics processing, signal processing, floating-point arithmetic processing, encryption, I/O processing, and so on. In particular and without further limitation, a central processing unit (CPU) and a graphics processing unit (GPU) are each an example of a logical processor.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, and similar hardware interface software.

“Code” means processor instructions, data (which includes constants, variables, and data structures), or both instructions and data.

Throughout this document, use of the optional plural “(s)” means that one or more of the indicated feature is present. For example, “margin extension(s)” means “one or more margin extensions” or equivalently “at least one margin extension”.

Whenever reference is made to data or instructions, it is understood that these items configure a computer-readable memory thereby transforming it to a particular article, as opposed to simply existing on paper, in a person's mind, or as a transitory signal on a wire, for example.

Operating Environments

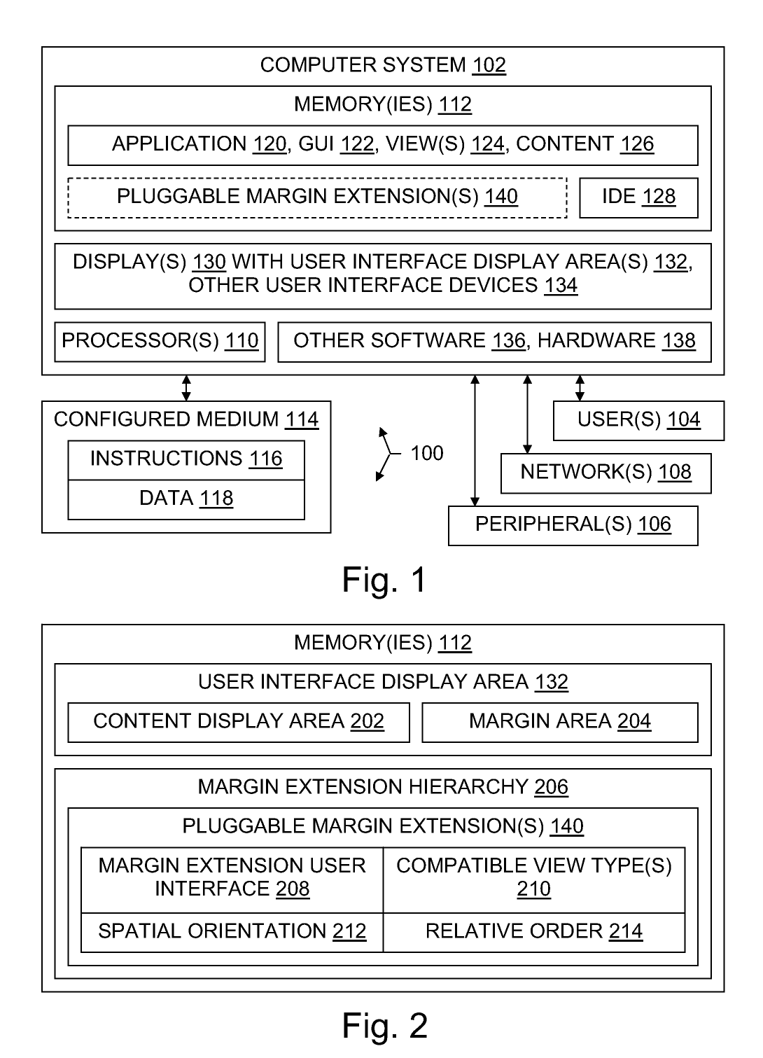

With reference to FIG. 1, an operating environment 100 for an embodiment may include a computer system 102. The computer system 102 may be a multiprocessor computer system, or not. An operating environment may include one or more computer systems, which may be clustered, client-server networked, and/or peer-to-peer networked. Some operating environments include a stand-alone (non-networked) computer system.

Human users 104 may interact with the computer system 102 by using displays, keyboards, and other peripherals 106. System administrators, developers, engineers, and end-users are each a particular type of user 104. Automated agents acting on behalf of one or more people may also be users 104. Storage devices and/or networking devices may be considered peripheral equipment in some embodiments. Other computer systems not shown in FIG. 1 may interact with the computer system 102 or with another system embodiment using one or more connections to a network 108 via network interface equipment, for example.

In some embodiments, networking interface equipment provides access to networks 108, using components such as a packet-switched network interface card, a wireless transceiver, or a telephone network interface, for example, will be present in the computer system. However, an embodiment may also communicate through direct memory access, removable nonvolatile media, or other information storage-retrieval and/or transmission approaches, or an embodiment in a computer system may operate without communicating with other computer systems.

The computer system 102 includes at least one logical processor 110, which may be a CPU or a GPU, for example. The computer system 102, like other suitable systems, also includes one or more memories 112. The memories 112 may be volatile, non-volatile, fixed in place, removable, magnetic, optical, and/or of other types. In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a memory 112. Other examples of memory 112 include built-in RAM, ROM, hard disks, and other storage devices which are not readily removable by users 104.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the memory 112/medium 114 in which they reside; when that memory is a functional part of a given computer system, the instructions 116 and data 118 also configure that computer system. Memories 112 may be of different physical types. Applications 120, with their graphical user interfaces (GUIs) 122, views 124, and user-generated content 126, and other items shown in the Figures may reside partially or entirely within one or more memories 112, thereby configuring those memories.

A given operating environment 100 may include an Integrated Development Environment (IDE) 128 which provides a developer with a set of coordinated software development tools. In particular, some of the suitable operating environments for some embodiments include or help create a Microsoft® Visual Studio® development environment (marks of Microsoft Corporation) configured to support program development. Some suitable operating environments include Java® environments (mark of Sun Microsystems, Inc.), and some include environments which utilize languages such as C++ or C# (“C-Sharp”), but teachings herein are applicable with a wide variety of programming languages, programming models, and programs, as well as with endeavors outside the field of software development that use editors or other applications having user interfaces.

The system 102 includes at least one display 130, such as a screen, monitor, panel, window, or the like. A display 130 is an example of a peripheral 106 and also includes memory 112 configured by pixels, vector graphics, and/or other graphic images. A display 130 has a user interface display area 132, which may be the entire visible area or a subset thereof. In addition to the display(s) 130, the system 102 may include other user interface devices 134 such as a keyboard, mouse, track ball, touch-sensitive pad, tablet, stylus, speakers, microphone, and/or camera. The display is driven by the application(s) 120, together with kernel code and a presentation (GUI) layer/library. The system may also include other software 136 and/or other hardware 138 not listed above.

Pluggable margin extensions 140 may be added to the operating environment 100, as discussed herein. FIG. 1 shows pluggable margin extensions 140 in a dashed outline, rather than a solid outline, to indicate that the margin extensions 140 are not part of the operating environment 100 but may be installed into the operating environment 100.

Systems

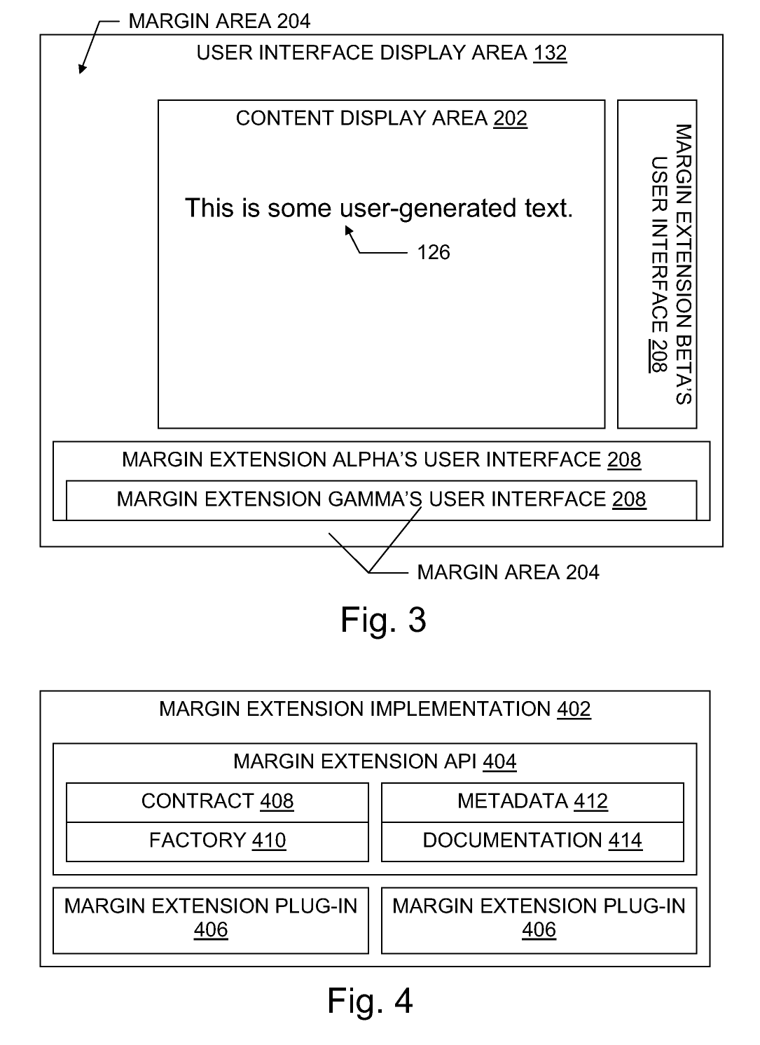

FIG. 2 further illustrates aspects of FIG. 1. As indicated in FIG. 2 and further detailed in an example in FIG. 3, the user interface display area 132 includes a content display area 202 and a margin area 204. Text, graphics, and/or other user-generated content 126 is displayed to users 104 in the content display area 202 of a display 130. In the FIG. 3 example, the margin area 204 surrounds the content display area 202 on four sides; in other embodiments, the margin area 204 is limited to three sides, two sides, or even one side. Also, the illustrated content display area 202 is rectangular, but in some embodiments the content display area 202 has a different shape, e.g., ovoid or circular. In some embodiments, margin extension user interfaces can only be placed within the margin area; they cannot overlay the content display area.

With further attention to FIG. 2, in some embodiments the pluggable margin extensions 140 are organized in a hierarchy 206. The criteria used by a developer to position margin extensions within the hierarchy 206 may vary. For example, a vertical scrollbar extension may indicate that it provides a vertical margin (i.e., has a vertical spatial orientation), and may indicate that it should be placed to the right of the textview as a desired position. In a mode in which the application is displaying a right-to-left language (like Hebrew), the vertical scrollbar margin may indicate a desired position left of the textview instead.

In some embodiments, each margin extension 140 includes a margin extension user interface 208, a list of one or more compatible view types 210, a list of one or more spatial orientations 212, and list of one or more relative orders 214. Each of these items is discussed further below.

A margin extension user interface 208 provides specific user interface functionality through which a user 104 and the view 124 interact. Some examples of margin extension user interface 208 functionality include scrollbars, line number margins, status bars, glyph margins, track changes margins, outlining margins, and so on.

As illustrated in FIG. 3, wherein a margin extension gamma's user interface overlays a margin extension alpha's user interface, in some configurations of some embodiments margin extension user interfaces may be overlaid, that is, drawn on top of one another. As also illustrated in FIG. 3, in some configurations of some embodiments an available portion of the margin area 204 may be left uninhabited when no compatible margin extension desires that position on screen.

A compatible view type 210 in a margin extension 140 specifies a type of view 124 the margin extension is designed to work with. Some examples of view types 210 include editable code view (main editor), read only code view (class definition window), read only text view (find results window), and so on.

A spatial orientation 212 in a margin extension 140 specifies a desirable and/or mandatory spatial orientation for the margin extension. In some embodiments, the available spatial orientations from which a margin extension developer can choose are expressly enumerated. Spatial orientations may be enumerated in a multi-directional position-independent set such as {vertical, horizontal}, for example, or a multi-directional set whose members specify a position relative to the content display area, e.g., {above, below, left-of, right-of}.

A relative order 214 in a margin extension 140 specifies a desirable and/or a mandatory order for the margin extension relative to at least one other margin extension, denoted here the “referenced” margin extension. The referenced margin extension may be identified in terms of a unique published name. For example, a line number margin extension can be referred to as “Line Number Margin”, and when other margin extensions specify their relative ordering to the line number margin extension, they would use “Line Number Margin” as an identifier.

With regard to FIG. 4, in some embodiments pluggable margin extensions 140 are implemented using a margin extension implementation 402 which includes a margin extension API provided, e.g., by the application 120 developer, and one or more margin extension plug-ins 406 provided, e.g., by other developers such as application vendor business partners or other third parties. The API 404 may include a contract 408, a factory 410, metadata 412, and documentation 414.

Generally, a contract 408 is an interface specification with which plug-ins 406 must be consistent to function properly. In some embodiments, a particular contract is defined using ITextViewMargin and IWpfTextViewMargin as shown below; “WPF” refers to Microsoft's Windows Presentation Foundation offering:

```
        namespace Microsoft.VisualStudio.Text.Editor
{
    using System;
    using System.Collections.Generic;
    using System.Text;
    /// A margin attached to an edge of an ITextView.
    public interface ITextViewMargin : IDisposable
    {
        /// For a horizontal margin, this is the height of
the margin since the width will be determined by the
ITextView. For a vertical margin, this is the width of the
margin since the height will be determined by the ITextView.
        /// ObjectDisposedException if margin is disposed.
        double MarginSize { get; }
        /// true if the margin is visible, false otherwise.
        /// ObjectDisposedException if margin is disposed.
        bool MarginVisible { get; set; }
    }
}
namespace Microsoft.VisualStudio.Text.Editor
{
    using System;
    using System.Windows;
    using Microsoft.VisualStudio.Utilities;
    /// WPF dependent interface for WPF Text View Margins.
    public interface IWpfTextViewMargin : ITextViewMargin
    {
        /// The FrameworkElement that renders the margin.
        /// ObjectDisposedException if margin is disposed.
        FrameworkElement VisualElement
        {
            get;
        }
    }
}
```

In some embodiments, a factory 410 implementation provided by the plug-in 406 developer is registered to make the plug-in available. Registration may be accomplished, e.g., by registering the factory 410 with a system registry such as a Microsoft Windows® system registry. In some embodiments, a particular factory such as the following is used; “MEF” refers to Microsoft's Managed Extensibility Framework offering:

```
        namespace Microsoft.VisualStudio.Text.Editor
{
    using System;
    using System.ComponentModel.Composition;
    using Microsoft.VisualStudio.Utilities;
    /// Creates an IWpfTextViewMargin for a given
IWpfTextViewHost.
    /// This is a MEF Component, and should be exported with
the following attribute:
    /// [Export(typeof(IWpfTextViewMarginProvider))]
    /// Exporters must supply an
TextViewMarginPlacementAttribute, ContentTypeAttribute,
    /// OrderAttribute, and NameAttribute.
    public interface IWpfTextViewMarginProvider
    {
        /// Creates an IWpfTextViewMargin for the given
IWpfTextViewHost.
        /// Parameter wpfTextViewHost is the
IWpfTextViewHost for which to create the IWpfTextViewMargin.
        /// Returns the IWpfTextViewMargin.
        /// The value may be null if this
IWpfTextViewMarginProvider decides they do not want to
participate.
        IWpfTextViewMargin
CreateWpfTextViewMargin(IWpfTextViewHost wpfTextViewHost);
    }
}
```

In some embodiments, metadata 412 defines metadata specified by a margin extension developer, such as relative order 214, user-generated-content type (view type 210), and application categories (a.k.a. application roles). An application role specifies whether a view is an editable code view, readonly code view, editable text view, readonly text view, and so on. For example, in some embodiments a find results window will have a content type of text, and a role of readonly text view, whereas a code definition window will have a content type depending on the language (e.g., C#), and a role of readonly code view. In particular, metadata is defined in some embodiments as follows:

```
        using System;
using System.Collections.Generic;
using System.Linq;
using System.Text;
using Microsoft.VisualStudio.Utilities;
namespace Microsoft.VisualStudio.Text.Editor
{
    public interface IWpfTextViewMarginMetadata :
IOrderable, IContentTypeMetadata
    {
        MarginPlacement TextViewMarginPlacement { get; }
    }
}
```

In some embodiments which utilize Microsoft's Windows Presentation Foundation offering, metadata implementation includes the following:

```
        namespace Microsoft.VisualStudio.Text.Editor
{
    using System;
    using Microsoft.VisualStudio.Utilities;
    using System.ComponentModel.Composition;
    /// The placement for an IWpfTextViewMargin relative to
the IWpfTextView.
    public enum MarginPlacement
    {
        Left = 0,
        Right = 1,
        Top = 2,
        Bottom = 3
    }
    /// Attribute used for setting the MarginPlacement for
an IWpfTextViewMarginProvider.
    public sealed class WpfTextViewMarginPlacementAttribute
: SingletonBaseMetadataAttribute
    {
        private MarginPlacement _textViewMarginPlacement;
        public
WpfTextViewMarginPlacementAttribute(MarginPlacement
textViewMarginPlacement)
        {
            _textViewMarginPlacement =
textViewMarginPlacement;
        }
        #region Public Properties
        /// The MarginPlacement property that states the
placement for the IWpfTextViewMargin this factory creates.
        public MarginPlacement TextViewMarginPlacement
        {
            get
            {
                return _textViewMarginPlacement;
            }
        }
        #endregion
    }
}
```

Some embodiments include a computer system 102 including a memory 112 which contains user interface data 118 in the form of a view 124 with an arrangement of margin extension user interfaces 208. The view has a view type 210 and a content display area 202. The user interface data is generated by code which identifies the view type of the view, locates a margin extension 140 compatible with the view type, and determines from the margin extension a desired position of a margin extension user interface near the content display area. The system places the margin extension user interface 208 on a display 130 near the content display area. The system also includes a processor 110 in operable communication with the memory to execute the code that takes the foregoing steps; “execute” is used in the broad sense noted above in the discussion of “executable”.

As used herein, a margin extension user interface 208 is “near” a content display area 202 if the shortest distance between those two items on a display is (a) less than the longest dimension of the margin extension user interface, and/or (b) less than the longest dimension of the content display area.

A margin extension may be loaded in a system 102 without necessarily being displayed. In some embodiments and some configurations, for example, the computer system 102 performs code which locates a second margin extension which is not compatible with the view type of the current view 124, and accordingly skips over the second margin extension. In this circumstance, the skipped margin extension user interface 208 is not placed on the display 130.

In some embodiments and some configurations, the code locates a second margin extension which is compatible with the view type of the current view 124. The code ascertains a relative order 214 of at least one of the margin extensions, and the system places a user interface 208 of the second margin extension on the display in a position based at least in part on the relative order. In some circumstances, the relative order 214 indicates that at least one of the margin extensions 140 is designed for overlay, and the system overlays two margin extension user interfaces 208 on the display 130.

Some systems 102 are equipped to respond with appropriate changes in margin extension user interface displays when the application view type changes. For example, suppose the current view's type 210 changes to a new view type after a margin extension user interface has been placed on the display under the former view type. Some embodiments will discover that the margin extension is not compatible with the new view type, and remove the margin extension user interface from the display. Similarly, some embodiments will discover that another margin extension (not currently displayed) is compatible with the new view type, and will add a user interface of the second margin extension to the display. Sometimes a margin extension is compatible with more than one view type, and may change its user interface content after noting a change in the view type.

Methods

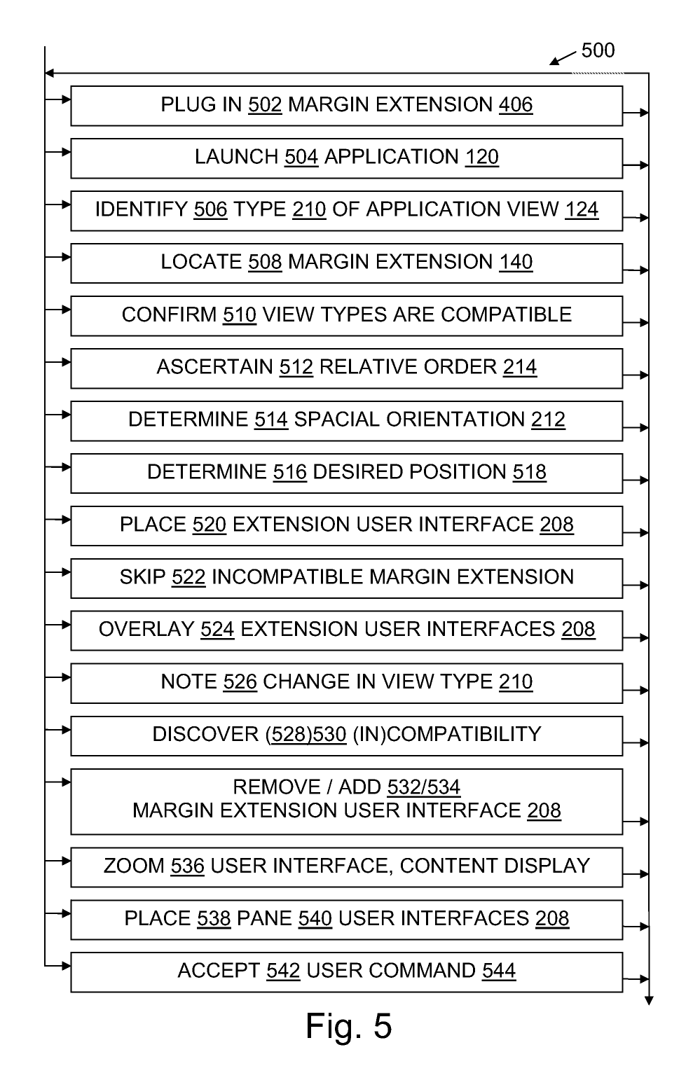

FIG. 5 illustrates some method embodiments in a flowchart 500. Methods shown in the Figures may be performed in some embodiments automatically, e.g., by locating and loading pluggable margin extensions 140 for an application 120 under control of a runtime, or a script, requiring little or no user input. Methods may also be performed in part automatically and in part manually unless otherwise indicated. In a given embodiment zero or more illustrated steps of a method may be repeated, perhaps with different parameters or data to operate on. Steps in an embodiment may also be done in a different order than the top-to-bottom order that is laid out in FIG. 5. Steps may be performed serially, in a partially overlapping manner, or fully in parallel. The order in which flowchart 500 is traversed to indicate the steps performed during a method may vary from one performance of the method to another performance of the method. The flowchart traversal order may also vary from one method embodiment to another method embodiment. Steps may also be omitted, combined, renamed, regrouped, or otherwise depart from the illustrated flow, provided that the method performed is operable and conforms to at least one claim.

During a plugging-in step 502, an embodiment accepts a margin extension plug-in 406. The metadata 412 for the plug-in 406 may also be accepted, or may be provided separately, or may be in the form of default values.

During a launching step 504, an embodiment launches an application 120 which has at least one view 124, and which is configured to work in conjunction with a margin extension 140, e.g., by receiving user commands transmitted through the margin extension.

During an identifying step 506, an embodiment identifies a type 210 characterizing a view 124 of an application 120. View type identification may be based on the content type of the underlying textbuffer and a textview role (a.k.a.application role). For example, in some embodiments a C# editor will have a C# content type, and the textview role is an editable code window. Margins that are meant for a C# editor such as a line number margin and a glyph margin will then be selected for the textview.

During a locating step 508, an embodiment locates a margin extension 140. Margin extensions may be located by using a directory, a registry, or another mechanism.

During a confirming step 510, an embodiment confirms that the view type 210 of the current view 124 is compatible with a given margin extension 140, namely, confirms that the current view type is among the types listed as compatible in the margin extension.

During an ascertaining step 512, an embodiment ascertains a relative order 214 for a given margin extension 140, e.g., by reading enumeration values, handles/links/pointers or the like.

During an orientation determining step 514, an embodiment determines what spatial orientation(s) 212 have been specified for a given margin extension 140.

During a desired position determining step 516, an embodiment determines a desired screen position 518 for a given margin extension 140. In some embodiments, the desired position is based on spatial orientation, relative order, and available space in the margin area. For example, in some embodiments a vertical scrollbar indicates that it has a vertical spatial orientation, has a desired position to the right of the textview, and has a desired relative order placing it directly to the right of the textview. Other vertical margins which want to be located to the right of the vertical scrollbar will then indicate that they have an order after the vertical scrollbar. Some embodiments determine a desired position 518, attempt to place 520 the margin extension user interface at that desired position, and then determine a next-desired position if the more desired position is not available, and so on.

During a placing step 520, an embodiment places a margin extension user interface 208 in a display 130, so a user can interact with the interface.

During a skipping step 522, an embodiment skips an incompatible margin extension, e.g., one whose view type(s) do not include the type 210 of the current view 124. The margin extension user interface 208 of the skipped margin extension is not displayed. However, a list of available/loaded margin extensions may be separately available regardless of the current view type.

During an overlaying step 524, an embodiment overlays one margin extension user interface 208 on another margin extension user interface 208 in a display 130, so a user can see both interfaces.

During a noting step 526, an embodiment notes a change in the view type 210 of a current view 124. For example, an event may be sent from an application to its registered margin extensions when the application changes views.

During a discovering step 528, an embodiment discovers an incompatible margin extension 140 after a change in the view type 210 of a current view 124. For example, in some embodiments a C# file will initially have a line number margin and perhaps a structure margin to detail the structure of the C# code. If the user then saves the file as text, the content type changes from C# to text. Although the line number margin is still valid, the structure margin is no longer valid as we are now dealing with strictly text. Therefore, the structure margin extension will be removed.

During a discovering step 530, an embodiment discovers a compatible margin extension 140 after a change in the view type 210 of a current view 124.

During a removing step 532, an embodiment removes from a display 130 a margin extension user interface 208 of a margin extension made incompatible by a change in the view type 210 of a view 124. The location of remaining margin extension user interfaces 208 may be adjusted to take advantage of screen space freed by the removal.

During an adding step 534, an embodiment adds to a display 130 a margin extension user interface 208 of a margin extension made compatible by a change in the view type 210 of a view 124. The location of previously placed margin extension user interfaces 208 may be adjusted to make room for the margin extension user interface 208 that is being added.

During a zooming step 536, an embodiment visually zooms (in and/or out) user-generated content 126 in conjunction with zooming a margin extension user interface 208 in a display 130. For example, in some embodiments a line number margin will attempt to zoom along with the content, but the scrollbar margins will attempt to stay the same size because a larger scroll margin would take up more screen real-estate without adding much more functionality.

During a multi-pane placing step 538, an embodiment places multiple margin extension user interfaces 208 in a display 130 corresponding to multiple panes 540 of an application's content display. For example, in some embodiments a margin may attempt to bind itself to an outer container, so that there is only one margin for all multipanes. An example is the drop down margin in the Microsoft Visual Studio® Integrated Development Environment (mark of Microsoft Corporation). A single drop down margin on the top of two split text views would be provided. However, other margins may be split with the views, for example each view would have its own scrollbar.

During a command accepting step 542, an embodiment accepts one or more user commands 544 from a user 104 by way of a margin extension user interface 208. For example, in some embodiments a line number margin accepts user mouse clicks, and if the user clicks on a line number, the margin extension in turn calls into the textview to get the entire line selected. In some embodiments, margins usually accept user input in the form of mouse clicks, but margins can contain other controls such as textboxes that accept user typing input, arrow keys, and so on.

Some embodiments provide a method for configuring a user interface of an application 120 being executed on a computing system 102. The method includes locating 508 a pluggable first margin extension 140 having a first user interface 208, and confirming 510 that the first margin extension is compatible with a view 124 of the application. For instance, the method may confirm 518 that the margin extension is compatible with a view which displays XML code, a view which displays assembly language code, or a view which displays another programming language code. The method determines 514 a spatial orientation 212 specified in the first margin extension, such as a spatial orientation belonging to a group which includes above, below, left-of, and right-of orientations about a content display area 202 of the view 124. The method also ascertains 512 an order 214 for the first margin extension relative to a second margin extension which has a second user interface that has already been placed in a user interface display area 132 of the computing system. The method then places 520 the first user interface of the first margin extension in the user interface display area in a location consistent with the spatial orientation and the order. After being placed in the display, the margin extension user interface 208 accepts 542 user commands 544 through the user interface 208 and responds by changing displayed information shown in the content display area.

Some embodiments also include zooming 536 a margin extension user interface in conjunction with zooming the content display area. Some include placing 538 multiple margin extension user interfaces 208 corresponding with multiple panes 540 in a split screen content display area. In some embodiments, the method ascertains 512 a relative z-order 214 of the margin extension and places 520 margin extension user interfaces over one another.

Examples are provided above and elsewhere to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

Configured Media

Some embodiments include a configured computer-readable storage medium 114, which is an example of a memory 112. Memory 112 may include disks (magnetic, optical, or otherwise), RAM, EEPROMS or other ROMs, and/or other configurable memory. The storage medium which is configured may be in particular a removable storage medium 114 such as a CD, DVD, or flash memory. A general-purpose memory 112, which may be removable or not, and may be volatile or not, can be configured into an embodiment using pluggable margin extensions 140, in the form of data 118 and instructions 116, read from a removable medium 114 and/or another source such as a network connection, to form a configured medium. The configured memory 112 is capable of causing a computer system to perform method steps for generating visual displays by transforming metadata 412 as disclosed herein. FIGS. 1 through 5 thus help illustrate configured storage media embodiments and method embodiments, as well as system embodiments. In particular, any of the method steps illustrated in FIG. 5, or otherwise taught herein, may be used to help configure a storage medium to form a configured medium embodiment.

Some embodiments provide a computer-readable medium 114 or another memory 112 which has been specifically configured by storing data 118 for a user interface of an application 120, such as an editor, that is being executed on a computing system 102. The configured memory includes a user interface display area 132 of the application. A view 124 presents content 126 in a content display area 202 within the user interface display area. A margin area 204 is located on the display outside the content display area but inside the user interface display area. A margin extension hierarchy 206 in the memory includes a plurality of pluggable margin extensions 140 ordered relative to one another. Each margin extension includes a margin extension user interface 208 for interfacing with a user to alter content display in the content display area, and a spatial orientation 212 for orienting the margin extension user interface within the margin area. The margin extensions' relative order 214 specifies a desired position of the margin extension user interface relative to the content display area, and/or a desired position of the margin extension user interface relative to a margin extension user interface of another specified margin extension.

In some margin extension embodiments, the relative order 214 specifies that the margin extension user interface is designed for overlay with a margin extension user interface of another specified margin extension.

Some margin extension embodiments include a view type 210 specifying compatibility of the margin extension with at least one type of view 124. The view type compatibility may be specified to include or to exclude, that is, the view types listed may be those which are compatible, or they may be view types that are not compatible with the margin extension. Some examples of view types include views intended for natural language textual content 126, and views intended for programming language source code textual content 126. In some embodiments, view types are based on the type of user-generated content which is being edited.

Some embodiments include a Microsoft editor having a user interface subsystem based on a textviewhost. A textviewhost uses a WPF grid control to host the textview and extensible margins. When a textviewhost is created, it is given an underlying textbuffer (which has a contenttype indicating its language association, for example C#), and an editor category. The textviewhost discovers all margin extensions 140 that satisfy the given contenttype and editor category. Contenttype is an example of a view type 210. Contenttype and editor category are examples of metadata 412. The textviewhost orders the margin extensions appropriately with respect to their spatial orientation 212. For example, all margin extensions that specify they want to append to the top of the textview (that is, above the content display area 202) will be grouped together and ordered with respect to each other. For each margin spatial orientation (top, bottom, left, right), the textviewhost checks to see whether there is an associated ordered group of margin extensions, and if so, the textviewhost will add a row or column for each margin extension so that it can be hosted in the WPF grid. For example, if there are two margin extensions that go above the textview, the textviewhost will dynamically create two rows on top of the textview, one to host each of the margin extensions.

Margin extensions can also specify that their margins (user interfaces 208) are over-layable, in which case other margin extensions can specify that they want to be overplayed on top of that margin extension. Such margin extensions are able to specify their z-ordering with respective to each other. Overlay margin extensions with the top z-order will have their margin user interfaces rendered last, meaning that lower overlay margins may have portions of their margin interfaces covered by other margin extension user interfaces. Overlay margins interact most successfully when their surface areas are transparent.

Margin extension implementation is a separate component from the textview implementation, allowing for minimized coupling. If the contenttype or editor category for a textviewhost changes, margins will be updated accordingly to ensure that margins with textview criteria no longer specified will be removed, and margins whose textview criteria are now satisfied (that were not previously satisfied) will be added to the textviewhost. Also, in some embodiments a margin extension's life is independent of a particular editor's life. Unlike built-in widgets, margin extension plug-ins can be added and removed without changing the editor.

### CONCLUSION

Although particular embodiments are expressly illustrated and described herein as methods, as configured media, or as systems, it will be appreciated that discussion of one type of embodiment also generally extends to other embodiment types. For instance, the descriptions of methods in connection with FIG. 5 also help describe configured media, and help describe the operation of systems and manufactures like those discussed in connection with FIGS. 1 through 4. It does not follow that limitations from one embodiment are necessarily read into another. In particular, methods are not necessarily limited to the data structures and arrangements presented while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification.

While exemplary embodiments have been shown in the drawings and described above, it will be apparent to those of ordinary skill in the art that numerous modifications can be made without departing from the principles and concepts set forth in the claims. Although the subject matter is described in language specific to structural features and/or methodological acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which come within the meaning and range of equivalency of the claims are to be embraced within their scope to the full extent permitted by law.

What is claimed is:

1. A memory configured by storing data for a user interface of an application being executed on a computing system which has a processor operable in communication with the memory, the configured memory comprising:
a user interface display area of the application;
a view for presenting content in a content display area within the user interface display area;
a margin area that is outside the content display area and inside the user interface display area; and
a margin extension hierarchy including a plurality of pluggable margin extensions configuring the memory, the margin extensions ordered relative to one another in the hierarchy, each margin extension including at least:
a margin extension user interface for interfacing with a user to alter content display in the content display area; and
a spatial orientation for orienting the margin extension user interface within the margin area.

2. The configured memory of claim 1, wherein the margin extensions are ordered relative to one another in the hierarchy by a relative order in each margin extension which specifies at least one of the following:
a desired position of the margin extension user interface relative to the content display area;
a desired position of the margin extension user interface relative to a margin extension user interface of another specified margin extension.

3. The configured memory of claim 1, wherein the margin extensions are ordered relative to one another in the hierarchy by a relative order in at least one margin extension which specifies that the margin extension user interface is designed for overlay with a margin extension user interface of another specified margin extension.

4. The configured memory of claim 1, wherein a margin extension further includes a view type specifying compatibility of the margin extension with at least one type of view.

5. The configured memory of claim 4, wherein the view type includes at least one of the following: natural language textual content, programming language source code textual content.

6. The configured memory of claim 1, further comprising an editor configuring the memory and including in the view display area a user interface for editing user-generated information.

7. The configured memory of claim 1, as further configured by plugging in another margin extension, thereby adding the margin extension to the margin extension hierarchy.

8. A computer system comprising:
a memory which contains user interface data in the form of a view with an arrangement of margin extension user interfaces, the view having a view type and a content display area, the user interface data generated by the following method:
identifying the view type of the view;
locating at least one pluggable margin extension compatible with the view type;
determining from the margin extension a desired position of a margin extension user interface near the content display area; and
placing the margin extension user interface on a display near the content display area; and
a processor in operable communication with the memory to facilitate the method.

9. The computer system of claim 8, wherein the method further includes locating at least a second margin extension which is not compatible with the view type, and skipping over the second margin extension and hence not placing a skipped margin extension user interface on the display.

10. The computer system of claim 8, wherein the method further includes:
locating a second margin extension which is also compatible with the view type;
ascertaining a relative order of at least one of the margin extensions; and
placing a user interface of the second margin extension on the display in a position based at least in part on the relative order.

11. The computer system of claim 10, wherein the relative order indicates that at least one of the margin extensions is designed for overlay, and the method further includes overlaying two margin extension user interfaces.

12. The computer system of claim 8, wherein the view type changes to a new view type after the placing step, and the method further includes:
discovering that the margin extension is not compatible with the new view type; and
removing the margin extension user interface from the display.

13. The computer system of claim 8, wherein the view type changes to a new view type after the placing step, and the method further includes:
discovering that a second margin extension is compatible with the new view type; and
adding a user interface of the second margin extension to the display.

14. A method for configuring a user interface of an application being executed on a computing system, the method comprising:
locating a pluggable first margin extension having a first user interface;
confirming that the first margin extension is compatible with a view of the application;
determining a spatial orientation specified in the first margin extension, the spatial orientation belonging to a group which includes above, below, left-of, and right-of orientations about a content display area of the view;
ascertaining an order for the first margin extension relative to a second margin extension which has a second user interface that has already been placed in a user interface display area of the computing system; and
placing the first user interface of the first margin extension in the user interface display area in a location consistent with the spatial orientation and the order.

15. The method of claim 14, further comprising zooming a margin extension user interface in conjunction with zooming the content display area.

16. The method of claim 14, further comprising placing multiple margin extension user interfaces corresponding with multiple panes in a split screen content display area.

17. The method of claim 14, wherein the ascertaining step ascertains a relative z-order of the margin extension and the placing step provides overlaid margin extension user interfaces.

18. The method of claim 14, wherein the confirming step confirms that the margin extension is compatible with a view of the application which displays one of the following: XML code, assembly language code, another programming language code.

19. The method of claim 14, further comprising accepting a user command entered in the margin extension user interface and responding to the command by changing displayed information shown in the content display area.

20. The method of claim 14, comprising placing at least three margin extension user interfaces in the user interface display area in respective locations which are consistent with the margin extensions' respective spatial orientations and orders.
